(19) United States
(12) Patent Application Publication
(10) Pub. No.: US 2002/0031333 A1
(43) Pub. Date: Mar. 14, 2002

(54) ON-THE FLY VIDEO EDITING DEVICE FOR CAPTURING AND STORING IMAGES FROM A VIDEO STREAM DURING PLAYBACK FOR SUBSEQUENT EDITING AND RECORDING

(76) Inventors: YOSHIZUMI MANO, CUPERTIMO, CA (US); CHECHU CHILAMAKURI, FREMONT, CA (US); HISATO SHIMA, SARATOGA, CA (US)

Correspondence Address: THOMAS B HAVERSTOCK, HAVERSTOCK & ASSOCIATES, 260 SHERIDAN AVE SUITE 420, PALO ALTO, CA, 94306

(21) Appl. No.: 08/940,165

(22) Filed: Sep. 30, 1997

(51) Int. Cl. H04N 5/92; G11B 27/00

(52) U.S. Cl. 386/52; 386/64

(57) ABSTRACT

A video editing device captures and stores selected video images currently being displayed on a television or other video viewing device and the accompanying audio information. The saved video images and accompanying audio information are preferably stored in a memory storage device for later retrieval and further editing by the viewer. Preferably, the memory storage device is a hard disk drive coupled to the television through an IEEE 1394 serial bus network. Alternatively, the memory device is included within the television for storing the series of images. Preferably, the viewer initiates the record operation when viewing a video stream by pressing an editing record button on a remote control device. In response to an editing record signal from the remote control device, the television will then initiate the recording of the information currently being displayed by routing the information to the memory storage device. After storing the information, the viewer can then subsequently replay the information by pressing an editing playback button on the remote control device. When the viewer presses the editing playback button, the television will preferably retrieve the last segment of stored information from the memory storage device and display it for the viewer. Alternatively, if more than one segment has been stored and not viewed, the segments are retrieved in succession beginning with the first segment of stored information which has not yet been played. The viewer can then further edit the stored information and add additional video, audio or other features to the stored information. When fully edited, the viewer can preview and then save the stored video information onto a video tape by transferring the stored video information from the memory storage device to an appropriate recording device coupled to the memory storage device, for recording.

### FIELD OF THE INVENTION

The present invention relates to the field of capturing and editing video images. More particularly, the present invention relates to the field of capturing and storing video images for subsequent retrieval, editing and recording.

### BACKGROUND OF THE INVENTION

The IEEE 1394 standard, “P1394 Standard For A High Performance Serial Bus,” Draft 8.0v2, Jul. 7, 1995, is an international standard for implementing an inexpensive high-speed serial bus architecture which supports both asynchronous and isochronous format data transfers. Isochronous data transfers are real-time transfers which take place such that the time intervals between significant instances have the same duration at both the transmitting and receiving applications. Each packet of data transferred isochronously is transferred in its own time period. An example of an ideal application for the transfer of data isochronously would be from a video recorder to a television set. The video recorder records images and sounds and saves the data in discrete chunks or packets. The video recorder then transfers each packet, representing the image and sound recorded over a limited time period, during that time period, for display by the television set. The IEEE 1394 standard bus architecture provides multiple channels for isochronous data transfer between applications. A six bit channel number is broadcast with the data to ensure reception by the appropriate application. This allows multiple applications to simultaneously transmit isochronous data across the bus structure. Asynchronous transfers are traditional data transfer operations which take place as soon as possible and transfer an amount of data from a source to a destination.

The IEEE 1394 standard provides a high-speed serial bus for interconnecting digital devices thereby providing a universal I/O connection. The IEEE 1394 standard defines a digital interface for the applications thereby eliminating the need for an application to convert digital data to analog data before it is transmitted across the bus. Correspondingly, a receiving application will receive digital data from the bus, not analog data, and will therefore not be required to convert analog data to digital data. The cable required by the IEEE 1394 standard is very thin in size compared to other bulkier cables used to connect such devices. Devices can be added and removed from an IEEE 1394 bus while the bus is active. If a device is so added or removed the bus will then automatically reconfigure itself for transmitting data between the then existing nodes. A node is considered a logical entity with a unique address on the bus structure. Each node provides an identification ROM, a standardized set of control registers and its own address space.

The IEEE 1394 cable environment is a network of nodes connected by point-to-point links, including a port on each node's physical connection and the cable between them. The physical topology for the cable environment of an IEEE 1394 serial bus is a non-cyclic network of multiple ports, with finite branches. The primary restriction on the cable environment is that nodes must be connected together without forming any closed loops.

The IEEE 1394 cables connect ports together on different nodes. Each port includes terminators, transceivers and simple logic. A node can have multiple ports at its physical connection. The cable and ports act as bus repeaters between the nodes to simulate a single logical bus. The cable physical connection at each node includes one or more ports, arbitration logic, a resynchronizer and an encoder. Each of the ports provide the cable media interface into which the cable connector is connected. The arbitration logic provides access to the bus for the node. The resynchronizer takes received data-strobe encoded data bits and generates data bits synchronized to a local clock for use by the applications within the node. The encoder takes either data being transmitted by the node or data received by the resynchronizer, which is addressed to another node, and encodes it in data-strobe format for transmission across the IEEE 1394 serial bus. Using these components, the cable physical connection translates the physical point-to-point topology of the cable environment into a virtual broadcast bus, which is expected by higher layers of the system. This is accomplished by taking all data received on one port of the physical connection, resynchronizing the data to a local clock and repeating the data out of all of the other ports from the physical connection.

For a consumer taking home videos on a video camera there is a lack of easy to use video editing systems which allow the consumer to edit their home videos. When taking home videos, it is desirable to have the ability to edit those videos and save the highlights of the recording for future viewing. It is also desirable to have the ability to add video, audio or special effects to the edited home videos. While many consumer editing systems exist, such systems are typically time consuming both to learn and to use. What is needed is a video editing system which is easy to learn and use.

### SUMMARY OF THE INVENTION

A video editing device captures and stores selected video images currently being displayed on a television or other video viewing device and the accompanying audio information. The saved video images and accompanying audio information are preferably stored in a memory storage device for later retrieval and further editing by the viewer. Preferably, the memory storage device is a hard disk drive coupled to the television through an IEEE 1394 serial bus network. Alternatively, the memory device is included within the television for storing the series of images. Preferably, the viewer initiates the record operation when viewing a video stream by pressing an editing record button on a remote control device. In response to an editing record signal from the remote control device, the television will then initiate the recording of the information currently being displayed by routing the information to the memory storage device. After storing the information, the viewer can then subsequently replay the information by pressing an editing playback button on the remote control device. When the viewer presses the editing playback button, the television will preferably retrieve the last segment of stored information from the memory storage device and display it for the viewer. Alternatively, if more than one segment has been stored and not viewed, the segments are retrieved in succession beginning with the first segment of stored information which has not yet been played. The viewer can then further edit the stored information and add additional video, audio or other features to the stored information. When fully edited, the viewer can preview and then save the stored video information onto a video tape by transferring the stored video information from the memory storage device to an appropriate recording device coupled to the memory storage device, for recording.

### BRIEF DESCRIPTION OF THE DRAWINGS

FIG. 1 illustrates a block diagram of an IEEE 1394 serial bus network including a computer system, a video cassette recorder (VCR), a video camera and a television.

FIG. 2 illustrates a block diagram of the internal components of the computer system 14.

FIG. 3 illustrates a block diagram of an IEEE 1394 serial bus network including a computer system, a VCR, a video camera, a television and an external hard disk drive.

FIG. 4 illustrates a block diagram of components within a television of an alternate embodiment of the present invention.

### DETAILED DESCRIPTION OF THE PREFERRED EMBODIMENT

A video editing device will capture and store a video image or series of video images and accompanying audio information currently being displayed on a television or other video viewing device at the command of a viewer. The information is stored in a memory storage device. Preferably, the memory storage device is a hard disk drive coupled to the television through an IEEE 1394 serial bus network. This hard disk drive is either resident within a computer system coupled to the television or the hard disk drive is an external hard disk drive coupled to the television. Alternatively, the memory device is included within the television for storing the image or series of images. In a further alternate embodiment, any appropriate memory device is used to store the image or series of images, including a flash memory device. Though non-volatile memory is preferred, a RAM storage can be substituted for the memory device.

The record operation is triggered by a viewer using a remote control device when the viewer desires to save something which is being displayed on the television. The viewer pushes an editing record button on the remote control device to instruct the television to initiate recording of the information currently being displayed. The television then routes the information currently being displayed to the memory storage device. Preferably, video images and accompanying audio information are selected and stored as long as the editing record button is depressed. In an alternate embodiment, the video images and accompanying audio information are selected and stored from the time the editing record button is first pressed until the editing record button is pressed a second time. After storing the information, the viewer can then subsequently replay the information for further editing, if necessary. Because the information is preferably sent over the IEEE 1394 serial bus network, the information is transmitted and stored in a digital format. Once the video information is fully edited, the viewer can replay the edited video information. The viewer can also save the edited video information onto a video tape by transferring the stored video information from the memory storage device to a video cassette recorder (VCR), video camera or other appropriate recording device coupled to the memory storage device, for recording.

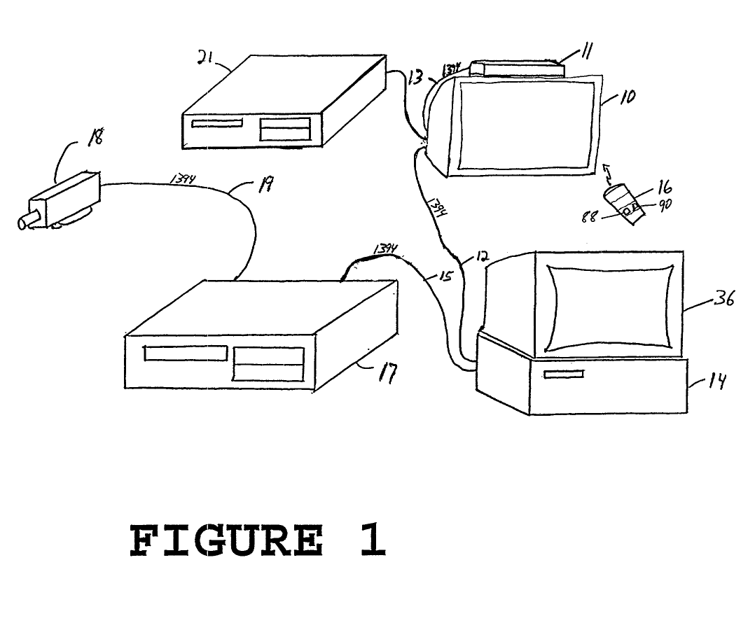

A block diagram of an exemplary IEEE 1394 serial bus network including a computer system, a VCR, a video camera and a television, is illustrated in FIG. 1. The computer system 14 includes an associated display 36 and is coupled to the television 10, by an IEEE 1394 serial bus cable 12. A settop box 11 is coupled to the television 10 by an IEEE 1394 serial bus cable 13. A VCR 17 is coupled to the computer system 14 by an IEEE 1394 serial bus cable 15. A video camera 18 is coupled to the VCR 17 by an IEEE 1394 serial bus cable 19. Together, the settop box 11, the television 10, the computer system 14, the VCR 17 and the video camera 18 form an IEEE 1394 serial bus network. A second VCR 21 is coupled to the television through a traditional VCR interface circuit and is not part of the IEEE 1394 serial bus network.

A wireless cursor control/input device 16 provides input and control signals to the television 10. The wireless cursor control/input device 16 includes an editing record button 88 and an editing playback button 90. The wireless cursor control/input device 16 also includes other input and control buttons typically associated with such devices, including but not limited to pause, fast forward and rewind buttons. The wireless cursor control/input device 16 preferably communicates with the television 10 using infrared signals. Alternatively, any other suitable cursor control/input device can be substituted for the device 16, including but not limited to a wired input device, a radio frequency input device and a wired or wireless keyboard with integral cursor control device.

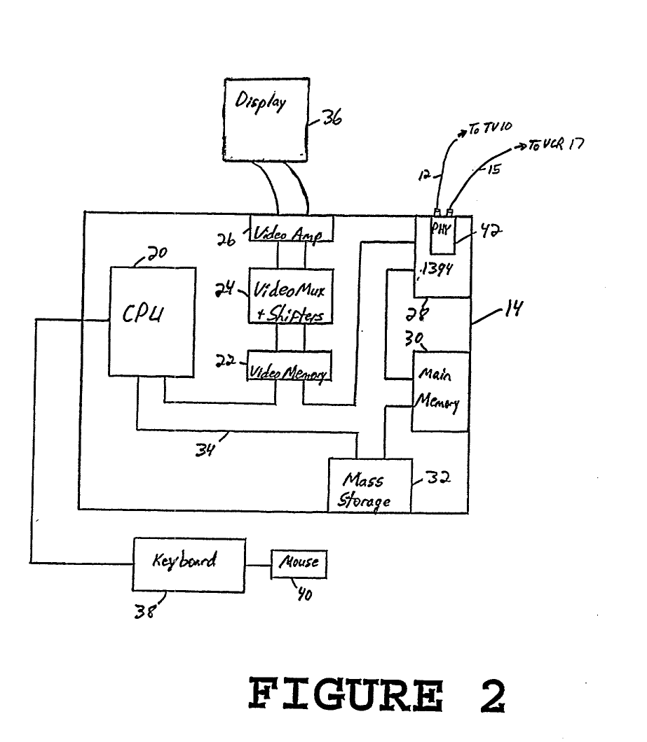

A block diagram of the internal components of the computer system 14 is illustrated in FIG. 2. The computer system 14 includes a central processor unit (CPU) 20, a main memory 30, a video memory 22, a mass storage device 32 and an IEEE 1394 interface circuit 28, all coupled together by a conventional bidirectional system bus 34. The interface circuit 28 includes the physical interface circuit 42 for sending and receiving communications on the IEEE 1394 serial bus. The physical interface circuit 42 is coupled to the television 10 and to the VCR 17, over the IEEE 1394 serial bus cables 12 and 15, respectively. In the preferred embodiment of the present invention, the interface circuit 28 is implemented on an IEEE 1394 interface card within the computer system 14. However, it should be apparent to those skilled in the art that the interface circuit 28 can be implemented within the computer system 14 in any other appropriate manner, including building the interface circuit onto the motherboard itself. The mass storage device 32 may include both fixed and removable media using any one or more of magnetic, optical or magneto-optical storage technology or any other available mass storage technology. The system bus 34 contains an address bus for addressing any portion of the memory 22 and 30. The system bus 34 also includes a data bus for transferring data between and among the CPU 20, the main memory 30, the video memory 22, the mass storage device 32 and the interface circuit 28.

The computer system 14 is also coupled to a number of peripheral input and output devices including the keyboard 38, the mouse 40 and the associated display 36. The keyboard 38 is coupled to the CPU 20 for allowing a user to input data and control commands into the computer system 14. A conventional mouse 40 is coupled to the keyboard 38 for manipulating graphic images on the display 36 as a cursor control device.

A port of the video memory 22 is coupled to a video multiplex and shifter circuit 24, which in turn is coupled to a video amplifier 26. The video amplifier 26 drives the display 36. The video multiplex and shifter circuitry 24 and the video amplifier 26 convert pixel data stored in the video memory 22 to raster signals suitable for use by the display 36.

After recording videos using a video camera such as the camera 18 (FIG. 1), a viewer can use the editing device of the present invention to edit and re-record those videos. To edit the video stream, the viewer causes the recorded stream to be displayed on the television 10 (FIG. 1), by instructing the video camera 18 (FIG. 1) to transmit the recorded video stream to the television 10 (FIG. 1). While the recorded video stream is displayed on the television 10 (FIG. 1), the viewer can then edit the video stream using the editing record button 88 (FIG. 1) on the wireless cursor control/input device 16 (FIG. 1). When a viewer, watching a video stream currently displayed on the television 10 (FIG. 1), pushes the editing record button 88 (FIG. 1), the video information and accompanying audio information representing the information currently being displayed on the television is transferred from the television 10 (FIG. 1) to the computer system 14 (FIG. 2) over the IEEE 1394 serial bus network for recording on the mass storage device 32 (FIG. 2). In this manner, while viewing a video stream, a user can select portions of the video stream which are to be saved for further editing and re-recording.

In the preferred embodiment of the present invention, video images and accompanying audio information are selected and stored as long as the editing record button 88 (FIG. 1) is depressed, allowing a viewer to select information for storing by pressing the editing record button 88 (FIG. 1). In an alternate embodiment, the video images and accompanying audio information are selected and stored from the time the editing record button 88 (FIG. 1) is first pressed, until the editing record button 88 (FIG. 1) is pressed a second time. The video images and accompanying audio information selected by the viewer using the editing record button 88 (FIG. 1) are preferably transmitted to the computer system 14 (FIG. 2) over the IEEE 1394 serial bus network for recording on the mass storage device 32 (FIG. 2).

Any type of video information which is displayed on the television 10 (FIG. 1) can be stored and edited in this manner. The television 10 (FIG. 1) will display video information from a number of sources including the settop box 11 (FIG. 1), the VCR 17 (FIG. 1) and the video camera 18 (FIG. 1), over the IEEE 1394 serial bus network, and also the VCR 21 (FIG. 1). Video information from any of these sources, which is displayed on the television 10 (FIG. 1) can be captured using the editing record button 88 (FIG. 1) and stored within the mass storage memory device 32 (FIG. 2).

Once video information is selected and stored, the viewer can then retrieve the information by depressing the editing playback button 90 (FIG. 1). When the editing playback button 90 (FIG. 1) is depressed, the television 10 (FIG. 1) will preferably retrieve the video information segment last stored using the instantaneous record button 88 (FIG. 1). Alternatively, if more than one video information segment has been stored and not retrieved, then when the editing playback button 90 (FIG. 1) is pressed, the television 10 (FIG. 1) will retrieve the stored video information segments in succession, beginning with the first stored video information segment. In a further alternate embodiment, two playback buttons are included, a first playback button to access the last stored video information segment and a second playback button to access all previously unviewed, stored video information segments, in succession. Once the viewer is in playback mode, the pause, next frame, previous frame, fast forward and rewind functions can be used to access all stored video information segments.

The retrieval of stored video information segments is accomplished by a read operation to the address within the mass storage device 32 (FIG. 2) where the information was stored. The mass storage device 32 (FIG. 2) will then retrieve that information and the computer system 14 (FIG. 2) will transmit the information to the television 10 (FIG. 1) over the IEEE 1394 serial bus network. The television 10 (FIG. 1) then displays the information for the viewer. The viewer can also use the pause, next frame, previous frame, fast forward and rewind functions when viewing and editing the information. The viewer can further edit the information using any available features including adding video and audio from another source, adding special effects and adding minimal video transitions, such as fading and cross-dissolve.

Once finally edited, the viewer can then save the information by recording it to a tape in an available recording device, such as the video camera 18 (FIG. 1) or the VCR 17 (FIG. 1). To record the finally edited information on a tape, the information is transmitted from the memory storage device 32 (FIG. 2) to the selected recording device over the IEEE 1394 serial bus network. In the manner as described, recorded videos or other video streams can be edited and re-recorded in an easy and efficient manner.

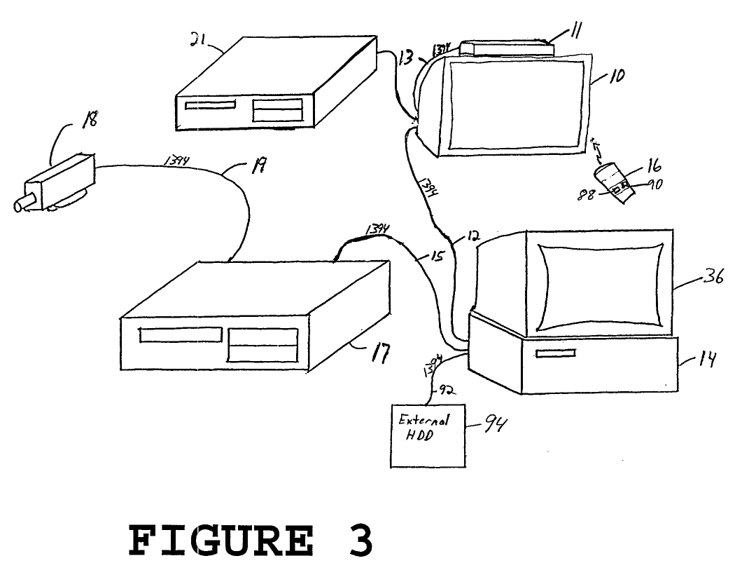

Within the preferred embodiment of the present invention, the video and accompanying audio information to be instantaneously recorded is transmitted from the television 10 (FIG. 1) to a mass storage device, as described above. While the mass storage device 32 (FIG. 2) within the computer system 14 (FIG. 2) can be used to store this information, it is also possible to use another mass storage device coupled to the television 10 (FIG. 1). A block diagram of an IEEE 1394 serial bus network including an external hard disk drive is illustrated in FIG. 3. This IEEE 1394 serial bus network includes the devices of FIG. 1 and the external hard disk drive 94 which is coupled to the computer system 14 by the IEEE 1394 serial bus cable 92.

In the network illustrated in FIG. 3, when the viewer presses the editing record button 88 to record video and accompanying audio information currently displayed on the television 10, the television 10 will transmit that information to the external hard disk drive 94 over the IEEE 1394 serial bus network. The external hard disk drive 94 will then store that video information for later retrieval.

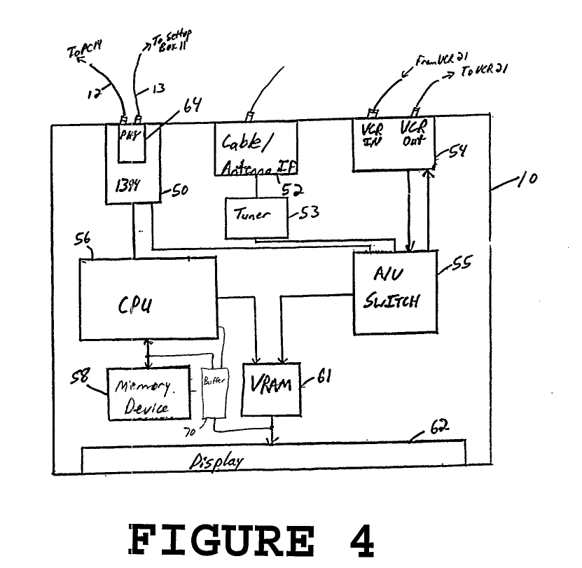

In still a further alternate embodiment, the television 10 includes a memory device which will store video information to be instantaneously recorded. A block diagram of components within this embodiment of the television 10 is illustrated in FIG. 4. An IEEE 1394 interface circuit 50 includes a physical interface circuit 64. The physical interface circuit 64 is coupled to the PC 14 and to the settop box 11, over the IEEE 1394 serial bus cables 12 and 13, respectively. The IEEE 1394 interface circuit 50 is coupled to a CPU 56 for controlling communications between the CPU 56 and devices coupled to the IEEE 1394 serial bus network. The IEEE 1394 interface circuit 50 is also coupled to an audio/video switch 55 for providing video signals from the devices coupled to the IEEE 1394 serial bus network. A cable/antenna interface circuit 52 is coupled to receive input signals from a coaxial cable or an antenna and to pass those signals through a tuner 53 to an audio/video switch 55. A traditional VCR interface circuit 54 is coupled to receive input signals from the VCR 21 and to output signals to the VCR 21. The VCR interface circuit 54 is also coupled to the audio/video switch 55 for directing audio/video signals to and from the VCR 21.

A memory device 58 is coupled to the CPU 56 for storing information. The audio/video switch 55 and the CPU 56 are coupled to the video random access memory (VRAM) circuit 61 for providing video input signals to the VRAM circuit 61 from the multiple sources. The VRAM circuit 61 provides the video signals to the display 62. If a compressed video stream of data is received by the television 10, that stream of data is decompressed before being sent to the VRAM circuit 61 by a coder/decoder circuit (CODEC) or other appropriate decompression engine, within the television 10. The VRAM circuit 61 is also coupled to a buffer 70 for providing the video signals to the buffer 70. The buffer 70 is also coupled to the memory device 58 and to the CPU 56. Each frame of video and accompanying audio information is loaded in the buffer 70 as it is transmitted to the display 62. If the editing record button 88 is pressed and the television 10 has been instructed to record the information currently being displayed, the CPU 56 then sends a command to the buffer 70 to output the information from the buffer 70 to the memory device 58. Otherwise the information for the next frame is stored within the buffer 70 as it is transmitted to the display 62.

Using the television 10, illustrated in FIG. 4, when the viewer presses the editing record button 88 to record information currently being displayed on the television 10, that information is transmitted to and stored within the memory device 58. When the editing playback button 90 is then pressed, the television 10 will read the information from the memory device 58 and display it on the display 62 for the viewer. The viewer can then further edit this information, if desired. Finally edited, the viewer can save the information to a tape by instructing the television 10 to transmit the information to a video recording device, such as the camera 18 or the VCR 17.

The video editing device of the present invention captures and stores video and accompanying audio information currently being displayed on a television or other video viewing device. The information is preferably stored in a memory storage device for later retrieval and editing by the viewer. Preferably, the memory storage device is a hard disk drive coupled to the television through an IEEE 1394 serial bus network. This hard disk drive is either resident within a computer system coupled to the television or the hard disk drive is an external hard disk drive coupled to the television. Alternatively, the memory device is included within the television for storing the information for editing. In a further alternate embodiment, any appropriate memory device is used to store the image or series of images, including a flash device.

The editing record operation is initiated by a viewer using a remote control device. The viewer pushes an editing record button on the remote control device to instruct the television to initiate recording of the information currently displayed on the television. The television then routes the information to the memory storage device. After storing the information, the viewer can then subsequently replay the information, by pressing an editing playback button. When the viewer presses the editing playback button, the television will retrieve the stored information and display it for the viewer. The viewer can then further edit the stored information and add additional video, audio or other features, if appropriate, to the stored information. Once the stored information is fully edited, the viewer can preview the edited video information and then save the stored information onto a video tape by transferring the stored video information from the memory storage device to a VCR, video camera or other appropriate recording device coupled to the memory storage device, for recording. In this manner, the viewer can quickly edit video information and re-record it for later replay.

The present invention has been described in terms of specific embodiments incorporating details to facilitate the understanding of principles of construction and operation of the invention. Such reference herein to specific embodiments and details thereof is not intended to limit the scope of the claims appended hereto. It will be apparent to those skilled in the art that modifications may be made in the embodiment chosen for illustration without departing from the spirit and scope of the invention. Specifically, it will be apparent to those skilled in the art that while the preferred embodiment of the present invention is used with an IEEE 1394 serial bus structure, the present invention could also be implemented on any other appropriate bus structures.

We claim:

1. A method of editing a video stream comprising the steps of:
a. receiving a video stream of images for display;
b. receiving a record instruction to instantaneously record information currently being displayed;
c. transmitting the information currently being displayed to a memory storage device; and
d. storing the information within the memory storage device.

2. The method as claimed in claim 1 wherein the information includes video information and accompanying audio information.

3. The method as claimed in claim 2 wherein the video information is transmitted in a digital format.

4. The method as claimed in claim 1 further comprising the steps of:
a. receiving a playback instruction to playback previously stored information;
b. retrieving the information from the memory storage device; and
c. displaying the information for further editing.

5. The method as claimed in claim 4 further comprising the step of transmitting the information from the memory storage device to a video recording device.

6. The method as claimed in claim 5 wherein the information is transmitted over an IEEE 1394 serial bus network.

7. The method as claimed in claim 6 wherein the memory storage device is a hard disk drive.

8. The method as claimed in claim 7 wherein the video information is transmitted and recorded in a digital format.

9. The method as claimed in claim 4 wherein the record and playback instructions are received from a remote control device.

10. An apparatus for editing a video stream comprising:
a. a display for displaying a video stream of images;
b. a transmitting circuit coupled to receive the information currently being displayed for transmitting the information when a record command is received;
c. a memory device coupled to the transmitting circuit for receiving and storing the information transmitted from the transmitting circuit;
d. a receiving circuit coupled to the memory device, to the display and to the transmitting circuit for retrieving the information from the memory device when a playback command is received, and sending the information to the display for editing.

11. The apparatus as claimed in claim 10 wherein the transmitting circuit is configured to transmit the information to a video recording device.

12. The apparatus as claimed in claim 11 wherein the transmitting circuit is an IEEE 1394 serial bus interface circuit.

13. The apparatus as claimed in claim 10 wherein the record and playback commands are received from an input device.

14. The apparatus as claimed in claim 13 wherein the input device is a wireless remote control device.

15. The apparatus as claimed in claim 10 wherein the information includes video and accompanying audio information.

16. The apparatus as claimed in claim 10 wherein the memory device and the display are included within a television.

17. The apparatus as claimed in claim 10 wherein the memory device is a hard disk drive.

18. A television for editing a video stream currently being displayed comprising:
a. a display for displaying video information;
b. a capturing circuit for capturing information currently being displayed when a record command is received; and
c. a communications circuit coupled to the capturing circuit and configured for coupling to a memory device for transmitting the information to the memory device for storing within the memory device and subsequently receiving the information from the memory device when a playback command is received and further wherein the communications circuit is also configured for transmitting the information to a video recording device.

19. The television as claimed in claim 18 wherein the memory device is external to the television and the communications circuit is an IEEE 1394 serial bus interface circuit.

20. The television as claimed in claim 18 wherein the memory device is internal to the television.

21. The television as claimed in claim 18 further comprising an input device for sending the record and playback commands.

22. The television as claimed in claim 21 wherein the input device is a wireless remote control device.

23. The television as claimed in claim 18 wherein the information includes video and accompanying audio information.
